(19) United States
(12) Patent Application Publication
(10) Pub. No.: US 2016/0307473 A1
(43) Pub. Date: Oct. 20, 2016

(54) NAMEPLATE ASSEMBLY AND FASTENER

(71) Applicant: FORD GLOBAL TECHNOLOGIES, LLC, Dearborn, MI (US)

(72) Inventors: Thomas Musleh, Canton, MI (US); Michael Musleh, Canton, MI (US); Linda D. VanFleteren, Troy, MI (US); James T. Colliflower, Waterford, MI (US); Darrell Dwight Huddleston, Manchester, MI (US)

(21) Appl. No.: 14/689,426

(22) Filed: Apr. 17, 2015

(51) Int. Cl. G09F 7/18; G09F 3/08; F16B 37/14

(52) U.S. Cl. CPC G09F 7/18; F16B 37/14; G09F 3/08; G09F 2007/1882; G09F 2007/1865

(57) ABSTRACT

A fastener and nameplate assembly are provided. The nameplate assembly includes a nameplate having a hollow mounting post. The fastener includes a screw body and a cap wherein the screw body has a head and a tip and the cap has an end overlying the head and a sidewall extending concentrically around the screw body toward the tip. When tightened to the mounting post of the nameplate, the cap seals against the workpiece to which the nameplate is mounted to protect the mounting post from moisture and corrosion.

### TECHNICAL FIELD

This document relates to the fastener field and to a nameplate assembly including a fastener for securing a nameplate to a motor vehicle.

### BACKGROUND

In many applications a workpiece with an integral post is secured to a second workpiece by means of a fastener that engages that post. For example, a nameplate for a motor vehicle may be provided with an integral post for receiving a cooperating fastener to secure the nameplate to a panel or other component of the motor vehicle.

This document relates to a new and improved fastener which effectively prevents mounting post corrosion over an extended service life.

### SUMMARY

In accordance with the purposes and benefits described herein, a new and improved fastener is provided. That fastener comprises a screw body and a cap. The screw body includes a head and a tip. The cap is secured to the head of the screw body. The cap includes an end overlying the head and a sidewall extending concentrically around the screw body toward the tip.

More specifically, an annular space is provided between the screw body and the sidewall of the cap. In one possible embodiment, the sidewall includes a multi-sided drive head. Further the cap is made of plastic and the head is overmolded into the cap.

In another possible embodiment, the sidewall includes a rim, a drive head and a portion between the rim and the drive head that collapses when the fastener is secured with a predetermined torque with the rim against the workpiece. In this embodiment the drive head is multi-sided allowing engagement and driving with a wrench or socket tool. Further, the cap may be made of plastic and the head may be overmolded into the cap.

In accordance with an additional aspect, a nameplate assembly is provided. That nameplate assembly comprises a nameplate including a hollow mounting post and a cooperating fastener. The fastener includes a screw body. The screw body has a head and a tip and the cap has an end overlying the head and a sidewall extending concentrically around the screw body toward the tip. An annular space is provided between the screw body and the sidewall.

In one possible embodiment, the sidewall includes a multi-sided drive head. In another possible embodiment, the sidewall includes a rim, a drive head and a portion between the rim and the drive head that collapses when the fastener is secured with a predetermined torque with the rim against the workpiece.

In either of the embodiments the cap may be made of plastic. Further, the head may be overmolded into the cap.

Still further, this document relates to a method of securing an exterior trim component with a hollow mounting post to a motor vehicle using a fastener having a screw body and a cap. That method includes the steps of: (a) positioning the exterior trim component on a workpiece of the motor vehicle into the hollow mounting post extending through an aperture in that workpiece and (b) securing the fastener to the exterior trim component so that the workpiece is captured between the component and the fastener and the cap engages the workpiece and completely seals around the mounting post. In one possible embodiment, the method also includes the step of collapsing a sidewall portion of the cap when the fastener is secured with a predetermined amount of torque.

In the following description, there are shown and described several preferred embodiments of the fastener and nameplate assembly. As it should be realized, the fastener and nameplate assembly are capable of other, different embodiments and their several details are capable of modification in various, obvious aspects all without departing from the fastener and nameplate assembly as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the fastener and nameplate assembly and together with the description serve to explain certain principles thereof. In the drawing figures:

FIG. 1 is an exploded perspective view of the first embodiment of the fastener.

FIG. 2 is a perspective view of the fastener illustrated in FIG. 1 from the tip end of the screw body.

FIG. 3 is a perspective view of the embodiment of the fastener illustrated in FIGS. 1 and 2 from the drive head end.

FIG. 4 is an exploded perspective view of a second embodiment of the fastener.

FIG. 5 is a perspective view of the second embodiment of the fastener illustrated in FIG. 4 from the tip end of the screw body.

FIG. 6 is a perspective view of the second embodiment of the fastener illustrated in FIGS. 4 and 5 from the drive head end.

FIGS. 7A and 7B illustrate the collapsed portion of the sidewall of the second embodiment of the fastener illustrated in FIGS. 4-6 with FIG. 7A illustrating the collapsible portion in its initial configuration and FIG. 7B illustrating the collapsible portion in its collapsed configuration after the fastener has been secured with the predetermined amount of torque.

FIG. 8 is a schematic cross-sectional view illustrating a nameplate assembly including a nameplate and a fastener of the type as illustrated in FIGS. 1-3.

FIG. 9 is a schematic cross-sectional view of a nameplate assembly including a nameplate and a fastener of the type illustrated in FIGS. 4-7B.

Reference will now be made in detail to the present preferred embodiments of the fastener and nameplate assembly, examples of which are illustrated in the accompanying drawing figures.

### DETAILED DESCRIPTION

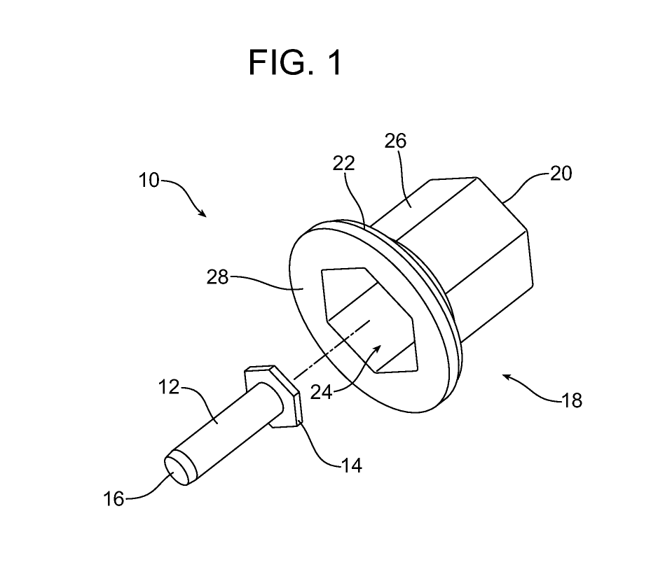

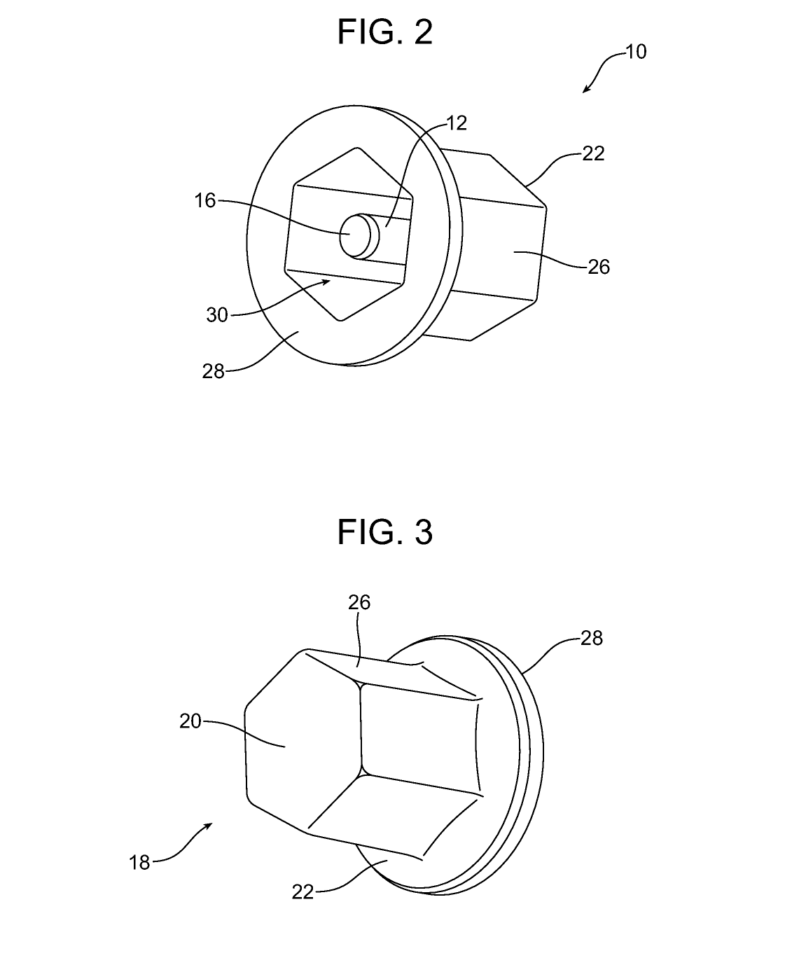

Reference is now made to FIGS. 1-3 illustrating a first embodiment of a fastener 10. As illustrated, the fastener 10 includes a screw body 12 having a head 14 at one end and a tip 16 at the other.

The fastener 10 also includes a cap, generally designated by reference number 18. The cap 18 includes an end 20 and a sidewall 22 defining a blind bore 24. More specifically, the sidewall 22 includes a multisided drive head 26 adapted for driving engagement with a wrench or socket tool and a rim 28.

In one possible embodiment the cap 18 is formed from plastic and the head 14 of the screw body 12 is overmolded into the cap with the sidewall 22 extending concentrically around the screw body toward the tip 16. Thus, an annular space 30 is provided between the screw body 12 and the sidewall 22 (FIG. 3).

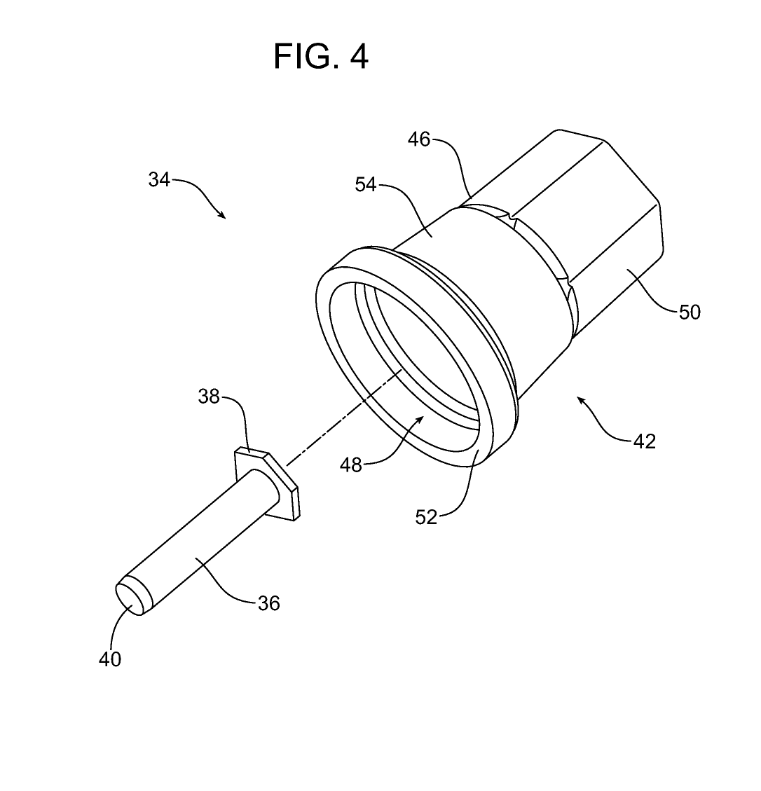

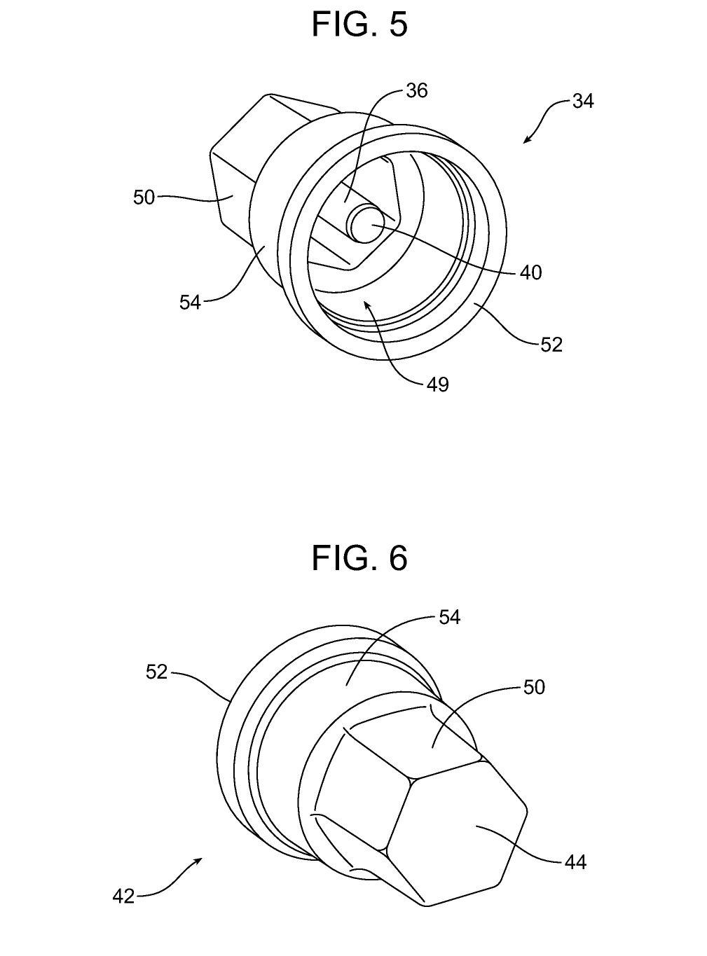

A second embodiment of the fastener 34 is illustrated in FIGS. 4-7B. The fastener 34 includes a screw body 36 having a head 38 at one end and a tip 40 at the other. The fastener 34 also includes a cap 42 having an end 44 and a sidewall 46 that define a blind bore 48.

In one possible embodiment the cap 42 is formed from plastic and the head 38 of the screw body is overmolded in the cap with the sidewall 46 extending concentrically around the screw body 36 toward the tip 40. Thus, a substantially annular space 49 is provided between the screw body 36 and the sidewall 46.

As further illustrated in the drawing figure, the sidewall 46 includes a drive head 50, having multiple sides allowing engagement and driving with a wrench or socket tool, and a rim 52. Further, the sidewall 46 of the fastener 34 includes a portion 54 between the rim 52 and the drive head 50 that is engineered to collapse when the fastener is secured with a predetermined torque with the rim 52 engaging the workpiece to which something is to be fastened.

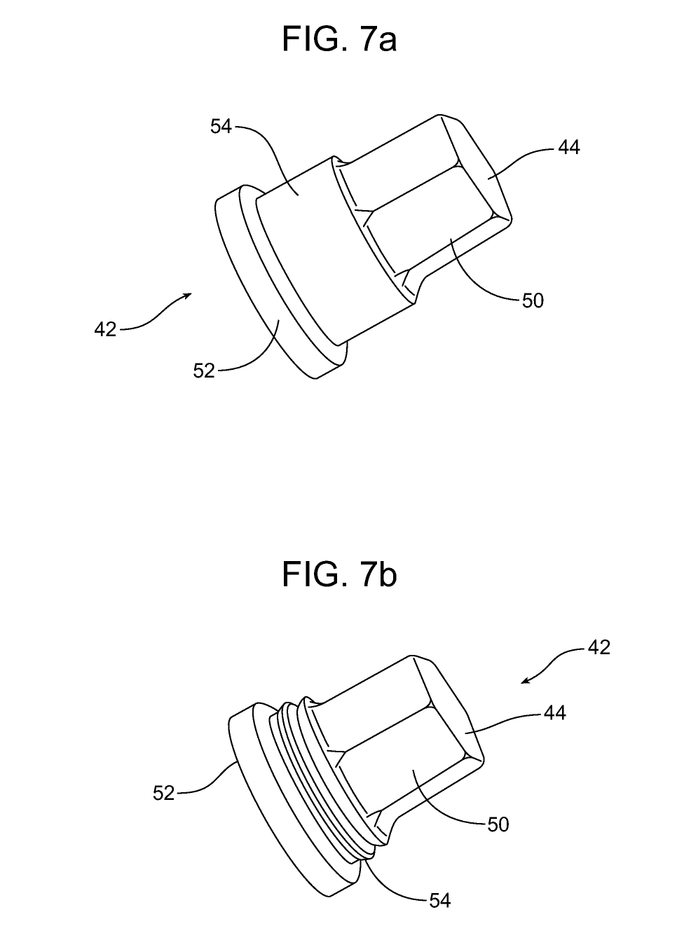

More specifically, FIG. 7A illustrates the sidewall 46 with the portion 54 in the initial, uncollapsed configuration while FIG. 7B illustrates the portion in the collapsed configuration.

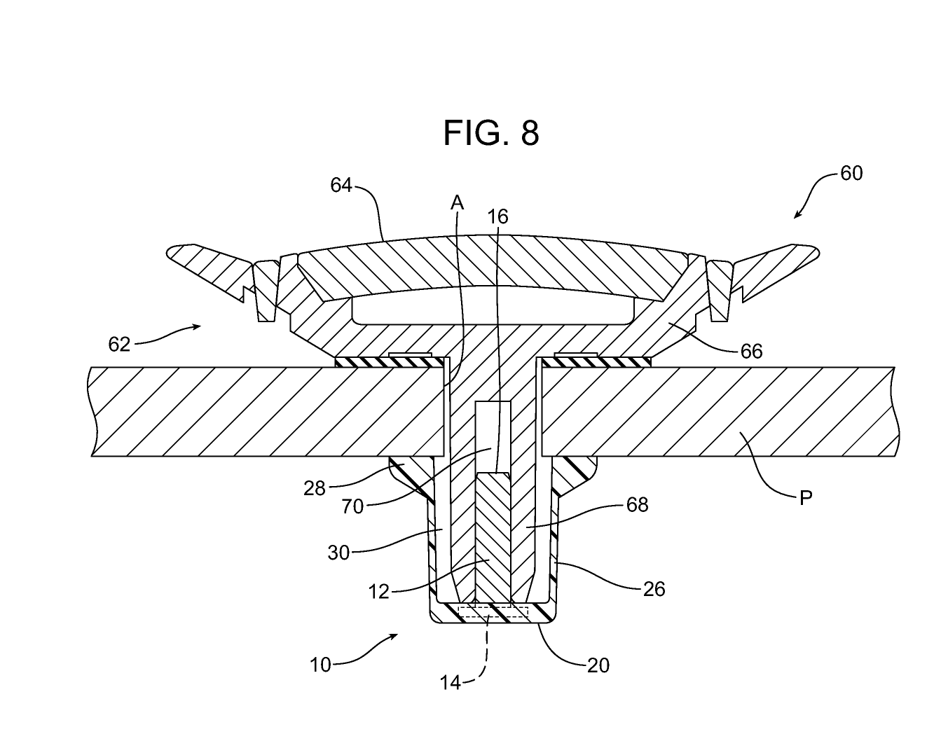

Reference is now made to FIG. 8 which illustrates a nameplate assembly 60 comprising a nameplate 62. The nameplate 62 includes a decorative facing 64 and a mounting bracket 66 including a hollow mounting post 68. In the illustrated embodiment, the nameplate 62 is secured to a workpiece such as a panel P of a motor vehicle by means of the fastener 10. More specifically, the mounting post 68 is inserted through the aperture A in the panel P with the name or any indicia on the decorative facing 64 properly oriented. Next, the tip 16 of the fastener 10 is aligned with the hollow bore 70 of the mounting post 68 and the fastener 10 is tightened by means of a wrench or socket tool which is brought into engagement with the drive head 26 of the cap 18. When fully tightened the rim 28 of the cap 18 engages and seals against the panel P thereby protecting the mounting post 68 from moisture and potential corrosion over a long service life.

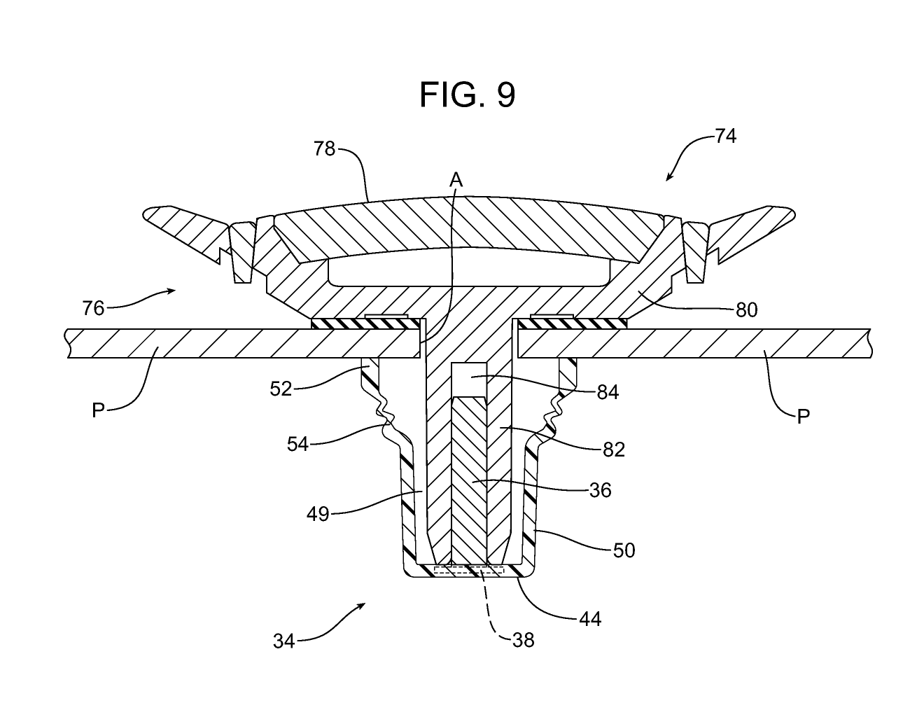

Reference is now made to FIG. 9 illustrating an alternative embodiment of the nameplate assembly 74 including a nameplate 76 having a decorative facing 78 keyed to a mounting bracket 80 including a mounting post 82 with a hollow bore 84.

In the illustrated embodiment the nameplate assembly 74 is secured to a panel P of a motor vehicle by means of a fastener 34. This is done by inserting the mounting post 82 through the aperture A in the panel P with the name or any other indicia on a decorative facing 78 properly oriented. Next the tip 40 of the fastener 34 is aligned with the hollow bore 84 of the mounting post 82. A wrench or socket tool is then used to engage the drive head 50 and tighten the fastener 34. Once the rim 52 engages the panel P, the individual continues to tighten the fastener 34 until a desired, predetermined amount of torque is applied thereby causing the collapsible portion 54 of the sidewall 46 to collapse. The collapsed portion 54 of the sidewall 46 provides a visual indication to the individual that the fastener 34 has been tightened properly and the nameplate 76 is properly secured to the panel P. Further, the collapsed portion 54 also indicates that the rim 52 of the cap 42 is providing the desired seal at the interface with the panel P to protect the mounting post 82 from moisture and corrosion. Here it should be appreciated that while the collapsible portion 54 of the sidewall does collapse, it remains intact to form a sealed environment around the mounting post 82 inside the cap 42.

The foregoing has been presented for purposes of illustration and description. It is not intended to be exhaustive or to limit the embodiments to the precise form disclosed. Obvious modifications and variations are possible in light of the above teachings. For example, while FIGS. 8 and 9 illustrate use of the fasteners 10, 34 to secure a nameplate assembly 60, 74 to a vehicle workpiece or panel P, it should be appreciated the fasteners may be used to secure substantially any exterior vehicle component including a mounting post to a motor vehicle workpiece or panel. All such modifications and variations are within the scope of the appended claims when interpreted in accordance with the breadth to which they are fairly, legally and equitably entitled.

What is claimed:

1. A fastener, comprising:
a screw body having a head and a tip; and
a cap secured to said head, said cap including an end overlying said head and a sidewall extending concentrically around said screw body toward said tip.

2. The fastener of claim 1, further including an annular space between said screw body and said sidewall.

3. The fastener of claim 2, wherein said sidewall includes a multi-sided drive head.

4. The fastener of claim 3, wherein said cap is made of plastic.

5. The fastener of claim 4, wherein said head is overmolded into said cap.

6. The fastener of claim 2, wherein said sidewall includes a rim, a drive head and a portion between said rim and said drive head that collapses when said fastener is secured with a predetermined torque with said rim against a workpiece.

7. The fastener of claim 6, wherein said drive head is multi-sided allowing engagement and driving with a wrench or socket tool.

8. The fastener of claim 6, wherein said cap is made of plastic.

9. The fastener of claim 8, wherein said head is overmolded into said cap.

10. A nameplate assembly, comprising:
a nameplate including a hollow mounting post; and
a fastener including a screw body and a cap wherein said screw body has a head and a tip and said cap has an end overlying said head and a sidewall extending concentrically around said screw body toward said tip.

11. The nameplate assembly of claim 10 further including an annular space between said screw body and said sidewall.

12. The nameplate assembly of claim 11, wherein said sidewall includes a multi-sided drive head.

13. The nameplate assembly of claim 12, wherein said cap is made of plastic.

14. The nameplate assembly of claim 13, wherein said head is overmolded into said cap.

15. The nameplate assembly of claim 11, wherein said sidewall includes a rim, a drive head and a portion between said rim and said drive head that collapses when said fastener is secured with a predetermined torque with said rim against a workpiece.

16. The nameplate assembly of claim 15, wherein said drive head is multi-sided allowing engagement and driving with a wrench or socket tool.

17. The nameplate assembly of claim 16, wherein said cap is made of plastic.

18. The nameplate assembly of claim 17, wherein said head is overmolded into said cap.

19. A method of securing an exterior trim component with a hollow mounting post to a motor vehicle using a fastener having a screw body and a cap, comprising:
positioning said exterior trim component on a workpiece of the motor vehicle with said hollow mounting post extending through an aperture in said workpiece; and
securing said fastener to said exterior trim component so that (a) said screw body is received in and engages said hollow mounting post, (b) said workpiece is captured between said exterior trim component and said fastener and (c) said cap engages said workpiece and completely seals around said mounting post.

20. The method of claim 19, including collapsing a sidewall portion of said cap when said fastener is secured with a predetermined amount of torque.
